(19) United States
(12) Patent Application Publication
(10) Pub. No.: US 2007/0188871 A1
(43) Pub. Date: Aug. 16, 2007

(54) Transparent substrate comprising an antireflection coating

(75) Inventors: Carinne Fleury, Lyon (FR); Nicolas Nadaud, Gentilly (FR); Sylvain Belliot, Paris (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: Saint-Gobain Glass France, Courbevoie (FR)

(21) Appl. No.: 10/567,901

(22) PCT Filed: Jul. 27, 2004
(86) PCT No.: PCT/FR04/50359

§ 371 Date: Dec. 7, 2006

(30) Foreign Application Priority Data
Aug. 13, 2003 (FR) 0309900

(51) Int. Cl. G02B 1/10

(52) U.S. Cl. 359/586

(57) ABSTRACT

Transparent substrate (6) comprising an antireflection coating on at least one of its faces, especially at normal incidence, made from a thin-film multilayer (A), characterized in that the multilayer comprises, in succession:
a first layer (1), having a refractive index n1 of between 1.8 and 2.3 and a geometrical thickness e1 of between 5 and 50 nm;
a second layer (2), having a refractive index n2 of between 1.35 and 1.65 and a geometrical thickness e2 of between 5 and 50 nm;
a third layer (3), having a refractive index n3 of between 1.8 and 2.3 and a geometrical thickness e3 of between 40 and 150 nm; and
a fourth layer (4), having a refractive index n4 of between 1.35 and 1.65 and a geometrical thickness e4 of between 40 and 150 nm.

The invention relates to a transparent substrate, specially made of glass, intended to be incorporated into glazing and provided, on at least one of its faces, with an antireflection coating.

According to other aspects of the invention, the coating may be of the solar-protection and/or low-emissivity type.

An antireflection coating usually consists of a multilayer comprising interferential thin layers, generally an alternation of layers based on a dielectric material of high refractive index and a dielectric material of low refractive index. When deposited on a transparent substrate, the function of such a coating is to reduce its light reflection and therefore to increase its light transmission. A substrate thus coated will therefore have its transmitted light/reflected light ratio increased, thereby improving the visibility of objects placed behind it. When it is sought to achieve a maximum antireflection effect, it is then preferable to provide both faces of the substrate with this type of coating.

There are many applications of this type of product: It may be used for windows in buildings, for glazing in sales furniture, for example as a shop window and as architectural curved glass, so as to better display what is in the window, even when the interior lighting is low compared with the exterior lighting. It may also be used as glass for counters.

Examples of antireflection coatings are described in Patents EP 0 728 712 and WO 97/43224.

Most antireflection coatings developed hitherto have been optimized to minimize light reflection at normal incidence, without taking into account the optical and aesthetic appearance of the glazing seen at oblique incidence, the mechanical durability of the multilayer and the resistance of the product to heat treatments (of the toughening, annealing and bending type). It is thus known that, at normal incidence, very low light reflection values R_{L} may be obtained with multilayers comprising four layers with a high-index layer/low-index layer/high-index layer/low-index layer alternation. The high-index layers are generally made of TiO₂ or Nb₂O₅, which have a high effective index, of about 2.45 and 2.35 respectively, and the low-index layers are usually made of SiO₂, with an index of about 1.45.

When it is desired for the multilayer to reserve its optical properties, mechanical properties (hardness, scratch resistance and abrasion resistance), and chemical resistance properties during a heat treatment (bending and/or toughening), it is known to use, as high-index layer, an Si₃N₄-based layer. However, its refractive index at 550 nm, which is substantially close to 2.0, limits the optical optimization possibilities.

The object of the invention is therefore to remedy the above drawbacks, by seeking to develop a coating that guarantees both good aesthetics of the glazing, whatever the angle of incidence, and high mechanical and chemical durability with good resistance to heat treatments (annealing, toughening, bending, folding), and to do so without compromising the economic and/or industrial feasibility of its manufacture.

The subject of the invention is firstly a transparent substrate, especially a glass substrate, having, on at least one of its faces, a thin-film multilayer based on dielectric materials of high refractive index and/or low refractive index, which is characterized in that at least one of the layers of high refractive index comprises a mixed silicon zirconium nitride.

Within the meaning of the invention, the term “layer” is understood to mean either a single layer or a superposition of layers, in which each of them satisfies the indicated refractive index and in which the sum of their geometrical thicknesses also retains the value indicated for the layer in question.

Within the meaning of the invention, the layers are made of a dielectric material, especially of the metal oxide, nitride or oxynitride types will be explained in detail later. However, it is not ruled out for at least one of them to be modified so as to be at least slightly conducting, for example, by doping a metal oxide, for example in order to give the antireflection multilayer also an antistatic function.

The invention applies preferably to glass substrates, but it also applies to transparent substrates based on a polymer, for example polycarbonate.

The invention therefore relates to an antireflection multilayer having at least one sequence of four alternating layers, namely layers of high and low refractive indices.

The thickness and refractive index criteria adopted in the invention make it possible to obtain an antireflection effect over a broad low-light-reflection band, having a neutral tint in transmission and an attractive appearance in reflection, whatever the angle of incidence at which the substrate thus coated is observed.

According to another aspect of the invention, it is aimed at any substrate provided with at least one thin-film multilayer, with a solar control or low-emissivity (low E) functionality.

In fact, the invention relates to transparent substrates, preferably rigid substrates of the glass type, which are provided with thin-film multilayers comprising at least one metal layer that can act on solar radiation and/or infrared radiation of long wavelength, for the construction of glazing.

The invention relates to multilayers comprising an alternation of metal layers, especially those based on silver, and dielectric layers of the metal oxide or nitride type, making it possible to give the glazing solar-protection or low-emissivity properties (double glazing for buildings, laminated windows for vehicles, etc.). It relates more particularly to glass substrates that are provided with such multilayers and have to undergo conversion operations involving a heat treatment at a temperature of at least 500° C.—this may in particular be a toughening, annealing or bending operation.

Rather than depositing the layers on the glass after its heat treatment (which raises considerable technical problems), it has been firstly sought to adapt the multilayers so that they can undergo such treatments, while still essentially maintaining their thermal properties. The aim has therefore been to prevent the functional layers, especially the silver layers, from deteriorating. One solution, disclosed in patent EP-506, 507, consists in protecting the silver layers by flanking them with metal layers that protect the silver layers. Such a multilayer is therefore able to be bent or toughened, insofar as it is at least as effective in infrared or solar radiation reflection after the bending or toughening treatment as beforehand. However, the oxidation/modification of the layers that have protected the silver layers under the effect of heat results in the optical properties of the multilayer being substantially modified, especially by increasing the light transmission and modifying the calorimetric response in reflection. This heating also tends to create optical defects, namely pitting and/or various small blemishes resulting in a significant level of haze (the expression “small blemishes” is understood in general to mean defects of a size less than 5 microns, whereas “pitting” is understood to mean defects with a size of greater than 50 microns, especially between 50 and 100 microns, with of course the possibility of also having defects of intermediate size, that is to say between 5 and 50 microns).

Secondly, it is therefore sought to develop such thin-film multilayers that are capable of preserving their thermal properties and their optical properties after heat treatment, by minimizing any appearance of optical defects. The challenge is thus to have thin-film multilayers of constant optical/thermal performance, whether or not they have to undergo heat treatments.

A first solution was proposed in Patent EP-847 965, which was aimed at multilayers of the type above (with two silver layers) and describes the use both of a barrier layer on top of the silver layers and an absorbent or stabilizing layer adjacent said silver layers and allowing them to be stabilized.

It describes multilayers of the type:
Si₃N₄/ZnO/Ag/Ti/ZnO/Si₃N₄ZnO/Ag/Ti/ZnO/Si₃N₄.

A second solution was proposed in patent FR 2 827 855, which recommends the use of a thin-film multilayer comprising an alternation of n functional layers A having reflection properties in the infrared and/or in solar radiation, especially metal layers, and of n+1 coatings B where n ≧1. Said coatings B comprise a layer or a superposition of layers made of dielectric material, so that each functional layer A is placed between two coatings B. The functional layer(s) is (are) based on silver and the oxygen diffusion barrier layers (the layers B) are especially based on silicon nitride. This multilayer also has the feature that at least one of the functional layers A is directly in contact with the dielectric coating B placed on top of it, and is in contact with the dielectric coating B placed beneath them via a layer C that is absorbent at least in the visible, of the optionally nitrided metal type. It proposes multilayers of the type:
Si₃N₄/Ti/Ag/Si₃N₄/Ag/Si₃N₄.

These solutions are satisfactory in most cases. However, there is an increasing need to have glass of very pronounced curvature and/or complex shape (double curvature, S-shaped curvature, etc.). This is particularly the case for glass used for automobile windshields or shop windows. In this case, the glass has to undergo locally differentiated treatments from the thermal and/or mechanical standpoint, as described in particular in patents FR-2,599,357, U.S. Pat. Nos. 6,158,247, 4,915,722 and 4,764,196. This imposes a particular constraint on thin-film multilayers—localized optical defects and slight variations in appearance in reflection from one point on the glazing to another may then be observed.

One of the objects of the invention is to seek to improve the energy and optical performance characteristics of the multilayers, while still maintaining their behavior after heat treatment (toughening, bending or annealing).

Whatever the type of multilayer (antireflection, low-emissivity or solar-protection multilayer), selection of the criteria is tricky since the inventors have taken into account the industrial feasibility of the product and the ability to obtain optimized optical properties in the visible range or in the infrared range, for various angle of incidence values, and to do so without compromising the mechanical durability and heat-treatment resistance properties of the multilayer.

Specifically for antireflection multilayers, the inventors have achieved this, in particular by lowering the value of R_{L} in the visible (calculated for a substrate provided with a single multilayer deposited on one of faces) by at least 3 or 4% at normal incidence.

For a substrate having the multilayer of the invention on at least one of its faces, the inventors have been able to obtain, in reflection, negative b* values in the (L*,a*,b*) colorimetry system that are, for a* and b*, less than 15 in absolute value.

This results in a significant reduction in reflections and a green-blue color in reflection (avoiding the yellowish or reddish appearance) that is currently deemed to be attractive in many applications, especially in the building field. The inventors have also found that these same multilayers can be toughened or bent with their optical properties preserved.

Specifically, the use of a dielectric material with an index greater than 2 allows the total thickness of the functional layers to be increased, thereby helping to improve the energy performance and/or aesthetics of the product.

Specifically for multilayers comprising functional layers that have to provide solar control, the inventors have achieved this, especially by improving the energy performance without degrading the performance from the aesthetic standpoint and both the mechanical and chemical durability standpoint, the multilayers of the invention being also suitable for undergoing a heat treatment (annealing, toughening or bending operation).

The two most striking features of the invention are the following:
it has been discovered that, contrary to the fact that zirconium nitride is particularly absorbent in the visible range, its absorbency is no longer predominant when it is present within a mixed silicon zirconium nitride (provided that, however, its content is controlled) and that said layer benefits from a substantial increase in the value of its overall refractive index; and
it has also been shown that the use of mixed Si₃N₄-based materials make it possible to obtain multilayers possessing mechanical resistance properties (abrasion resistance, scratch resistance and cleaning resistance) and heat treatment (annealing, toughening, bending) resistance properties of the multilayers that are not degraded compared with those of multilayers based on pure Si₃N₄.

Given below are the preferred ranges of the geometrical thicknesses and of the indices of the four layers of the antireflection multilayer according to the invention, this multilayer being called A:
n₁ and/or n₃ are between 2.00 and 2.30, especially between 2.15 and 2.25 and preferably close to 2.20;
n₂ and/or n₄ are between 1.35 and 1.65;
e₁ is between 5 and 50 nm, especially between 10 and 30 nm or between 15 and 25 nm;
e₂ is between 5 and 50 nm, especially less than or equal to 35 nm or less than or equal to 30 nm, especially being between 10 and 35 nm;
e₃ is between 40 and 120 nm and preferably between 45 and 80 nm; and
e₄ is between 45 and 110 nm and preferably between 70 and 100 nm.

The most appropriate materials for forming the first and/or the third layer of the antireflection-type multilayer A, those having a high index, are based on a mixed silicon zirconium nitride or on a mixture of these mixed nitrides. As a variant, these high-index layers are based on mixed silicon tantalum nitrides or on a mixture thereof. All these materials may optionally be doped in order to improve their chemical resistance and/or mechanical and/or electrical properties.

The most appropriate materials for forming the second and/or the fourth layer of the multilayer A, those of low index, are based on silicon oxide, silicon oxynitride and/or silicon oxynitride or else based on a mixed silicon aluminum oxide. Such a mixed oxide tends to have better durability, especially chemical durability, than pure SiO₂ (an example of this is given in patent EP-791 562). It is also possible to adjust the respective proportion of the two oxides in order to improve the expected durability without excessively increasing the refractive index of the layer.

Thus, the substrates incorporating such layers in their multilayer may undergo, without any damage, heat treatment such as an annealing, toughening, bending or even folding operation. These heat treatments do not impair the optical properties, whatever the angle of incidence at which the substrates thus coated are observed, this functionality being particularly important in the case of windows for buildings.

It is thus possible to have a single multilayer configuration whether or not the carrier glass is intended to undergo a heat treatment. Even if it is not intended to be heated, it remains advantageous to use at least one nitride layer, as this improves the mechanical and chemical durability of the multilayer in its entirety.

In one particular embodiment, the first and/or third layer, those of high index, may in fact consist of several superposed high-index layers, one of these layers being based on zirconium-doped silicon nitride, namely Zr:Si₃N₄.

The glass chosen for the substrate coated with the multilayer A according to the invention or for the other substrates that are associated therewith in order to form a glazing unit, may in particular be, for example, extra clear of the “Diamant” type, or clear of the “Planilux” type or tinted of the “Parsol” type, these three products being sold by Saint-Gobain Vitrage, or else they may be of the “TSA” or “TSA ++” type, as described in patent EP 616 883. The glass may also be optionally tinted, as described in patents WO 94/14716, WO 96/00194, EP 0 644 164 and WO 96/28394. It may also be glass that filters radiation of the ultraviolet type.

The subject of the invention is also glazing that incorporates substrates provided with the multilayer A defined above. The glazing in question may be “monolithic”, that is to say composed of a single substrate coated with the multilayer on one of its faces. Its opposite face may be devoid of any coating, being bare, or covered with another coating B having a functionality different from or identical to that of the multilayer A.

This may be a coating providing a solar-protection function (for example using one or more silver layers surrounded by dielectric layers, or layers that furthermore include nitrides such as TiN or ZrN, or layers made of metal oxides, steel or an Ni—Cr alloy), providing a low-emissivity function (for example a coating made of doped metal oxide such as F:SnO₂ or a tin-doped indium oxide ITO or one or more silver layers), or providing an electromagnetic shielding function, an antistatic function (a doped metal oxide or an oxide substoichiometric in oxygen), or a heating layer (doped metal oxide, for example made of Cu or Ag) or an array of heating wires (copper or tungsten wires or bands screen-printed using a conductive silver paste), antimisting function (using a hydrophilic layer), antirain function (using a hydrophobic layer, for example based on a fluoropolymer) or an antisoiling function (a photocatalytic coating comprising TiO₂ at least partly crystallized in anatase form).

Other useful glazing incorporating a substrate coated according to the invention has a laminated structure, comprising two glass substrates joined together by one or more sheets of a thermoplastic, such as polyvinyl butyral (PVB). In this case, one of the two substrates is provided, on the external face (on the opposite side from that where the glass joins the thermoplastic sheet), with the antireflection multilayer according to the invention. The other glass, again on the external face, possibly being, as previously, bare, coated with layers having another functionality, coated with the same antireflection multilayer or with another multilayer type (B), or else with a coating having another functionality as in the previous case (this other coating may also be deposited not on the face on the opposite side from the join but on one of the faces of one of the rigid substrates that faces the thermoplastic joining sheet). The laminated glazing may thus be provided with an array of heating wires, with a heating layer or with a solar-protection coating “within” the laminate.

The invention also includes glazing units provided with the antireflection multilayer of the invention, which are multiple glazing units, that is to say those using at least two substrates separated by an intermediate gas layer (double or triple glazing). Here again, the other faces of the glazing unit may also be antireflection-treated or may have another functionality.

It should be noted that this other functionality may also consist in having, on one and the same face, the antireflection multilayer and the multilayer having another functionality (for example by surmounting the antireflection coating with a very thin antisoiling coating layer), the addition of this further functionality not being, of course, to the detriment of the optical properties.

Thus, according to one advantageous feature of the invention, this other functionality that is added to the antireflection multilayer according to the invention, may consist of a DLC (diamond-like carbon) layer.

According to an advantageous feature of the invention, this other functionality that is added to the antireflection multilayer according to the invention may thus consist of a layer acting as mechanical protection (and/or scratch-resistant layer) of the hydrogenated tetrahedral amorphous carbon ta-C:H (also called DLC) type. These layers composed of carbon and hydrogen atoms are characterized by a high concentration (possibly up to 80%) of sp³ carbon bond, giving the layers their high hardness (this hardness, measured by nano-indentation, possibly being up to 80 Gpa), a low-friction coefficient (that can be measured macroscopically and by a nano-scratch) and good resistance to chemical attack.

Since the formation of sp³ bonds is energetically unfavorable, it requires a large energy influx, which may be provided by ion bombardment and/or a high temperature. Thus, such a layer may be fabricated by the dissociation of a precursor containing, inter alia, hydrogen and carbon (CH₄, C₂H₆, C₂H₄, C₂H₂, etc., but may also derive from HMDSO or TEOS containing other atoms such as silicon or aluminum for example) in an ionic source (which may or may not be based on the “anode layer source” principle, with or without a grid to accelerate the ions, excited by a DC or AC current or by microwave radiation) and the ion flux thus created being directed onto the substrate—which may or may not be heated—with energies between 100 and 2000 eV. To optimize the optical properties (refractive index and absorption coefficient of the layer, and total transmission of the multilayer) and to reduce the strains in the layer thus created, it may be necessary to control and increase the hydrogen content (to atomic concentrations possibly up to 40 at %) in the layer, for example by the addition of gaseous hydrogen into the layer.

The subject of the invention is also a process for manufacturing the glass substrates with a coating according to the invention. One process consists in depositing all of the layers, in succession one after another, by a vacuum technique, especially by magnetically enhanced sputtering or glow discharge sputtering. Thus, the oxide layers may be deposited by reactive sputtering of the metal in question in the presence of oxygen and the nitride layers in the presence of nitrogen. To obtain SiO₂ or Zr:Si₃N₄, it is possible to start with a silicon target or a zirconium target that is lightly doped with a metal such as aluminum in order to make it sufficiently conducting.

Yet another subject of the invention is a plane or tubular, magnetron sputtering target for obtaining at least one layer comprising SiₓZr_{y}Al_{z}, which is characterized in that the Si/Zr ratio at the target is slightly different from that of the layer with a difference of 0.1 to 0.5.

This target may be obtained using a plasma spray process by a process for pressing/sintering an aluminum/zirconium/silicon powder blend by HIP (hot isostatic pressing) or CIP (cold isostatic pressing).

The subject of the invention is also the applications of this glazing, including most of those already mentioned, namely shop window, display case or counter, windows for buildings, or for any display device, such as computer or television screens, any glass furniture, any decorative glass, or motor-vehicle sun roofs. Such glazing may be bent/toughened after deposition of the layers.

The details and advantageous features of the invention will now emerge from the following non-limiting examples, with the aid of the figures, namely:

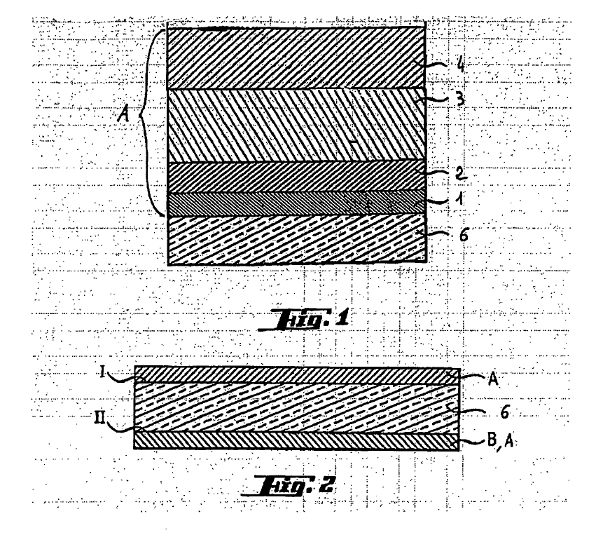

FIG. 1, which shows a substrate provided on one of its two faces with a four-layer antireflection multilayer coating according to the invention; and

FIG. 2, which shows a substrate provided on each of its faces with a four-layer antireflection multilayer coating according to the invention.

All the examples 1 to 4 relate to four-layer antireflection multilayer coatings. The layers were all deposited conventionally by magnetically enhanced reactive sputtering, in an oxidizing atmosphere using an Si or metal target, to produce the SiO₂ or metal oxide layers, and using an Si or metal target in a nitriding atmosphere, to produce the nitrides, and in a mixed oxidizing/nitriding atmosphere to produce the oxynitrides. The Si targets may contain another metal in small amount, especially Zr or Al, in particular so as to make them more conducting.

Given below are the compositions of zirconium-doped Si₃N₄ layers that were used in the examples below:

| Doping | Refractive index and | Si/Zr atomic |
|---|---|---|
| type | absorption | ratio |
| Zr:Si₃N₄ | N = 2.20; abs = 1% | 5.0 |
| Zr:Si₃N₄ | N = 2.25; abs = 1.5% | 4.60 |

### EXAMPLE 1

(6): glass
(1): Si₃N₄ (index n₁=2)
(2): SiO₂ (index n₂=1.46)
(3): Zr:Si₃N₄ (index n₃=2.2)
(4): SiO₂ (index n₄=1.46)

The glass 6 of FIG. 1 was a clear silica-soda-lime glass 4 mm in thickness, sold under the name PLANILUX by Saint-Gobain Vitrage.

This glass constituted monolithic glazing and was provided on both its faces with an antireflection multilayer according to the invention:
SiO₂/Zr: Si₃N₄/SiO₂/Si₃N₄/glass/Si₃N₄/SiO₂/Zr: Si₃N₄/SiO₂ (one layer of Zr: Si₃N₄).

The table below gives the index nᵢ and the geometrical thickness eᵢ in nanometers for each of the layers.

| EXAMPLE 1 | LAYER (1) | LAYER (2) | LAYER (3) | LAYER (4) |
|---|---|---|---|---|
| nᵢ | 2 | 1.46 | 2.2 | 1.46 |
| eᵢ | 20 nm | 35 nm | 117 nm | 85 nm |

The following table gives the optical parameters, in the (L*,a*,b*) plot, for various angles of incidence.

| | | | | | | | | | between Θ = 0° |
|---|---|---|---|---|---|---|---|---|---|
| Multilayer | Θ = 0° | Θ = 10° | Θ = 20° | Θ = 30° | Θ = 40° | Θ = 50° | Θ = 60° | Θ = 70° | and Θ = 70° |
| Example 1 | a* = −3 | a* = −3 | a* = 1 | a* = 4 | a* = 5 | a* = 4 | a* = 3 | a* = 2 | Δa* = 8 |
| | b* = −10 | b* = −10 | b* = −9 | b* = −7 | b* = −3 | b* = −0.5 | b* = 0.5 | b* = 0.8 | Δb* = 11 |

This multilayer is particularly suitable for a building application, for which the color in reflection is neutral (close to gray-blue), the light reflection is very substantially less than 2%, the a* and b* values are substantially less in absolute value than 10, and this color neutrality in reflection is maintained for angles of incidence between 0° and 70°.

### EXAMPLE 2

(6): glass
(1): Zr:Si₃N₄ (index n₁=2.2)
(2): SiO₂ (index n₂=1.46)
(3): Zr:Si₃N₄ (index n₃=2.2)
(4): SiO₂ (index n₄=1.46)

The glass 6 of FIG. 1 was provided on both its faces with an antireflection coating according to the invention of the type:
SiO₂/Zr:Si₃N₄/SiO₂/Zr:Si₃N₄/glass/Zr:Si₃N₄/SiO₂/Zr:Si₃N₄/ SiO₂.

The table below gives the index nᵢ and the geometrical thickness eᵢ in nanometers for each of the layers.

| EXAMPLE 2 | LAYER (1) | LAYER (2) | LAYER (3) | LAYER (4) |
|---|---|---|---|---|
| nᵢ | 2.2 | 1.46 | 2.2 | 1.46 |
| eᵢ | 15 nm | 18 nm | 98 nm | 86 nm |

The following table gives the optical parameters, in the (L*,a*,b*) plot, for various angles of incidence.

| | | | | | | | | | between Θ = 0° |
|---|---|---|---|---|---|---|---|---|---|
| Multilayer | Θ = 0° | Θ = 10° | Θ = 20° | Θ = 30° | Θ = 40° | Θ = 50° | Θ = 60° | Θ = 70° | and Θ = 70° |
| Example 2 | a* = −5 | a* = −5 | a* = −6 | a* = −4 | a* = 1.5 | a* = 6.5 | a* = 7.5 | a* = 6 | Δa* = 13 |
| | b* = −5 | b* = −4 | b* = −1 | b* = 1 | b* = −0.5 | b* = −3 | b* = −3 | b* = −2 | Δb* = 6 |

This multilayer is particularly suitable for a building application, for which the color in reflection is neutral (close to gray-blue), the light reflection is very substantially less than 2%, the a* and b* values are substantially less in absolute value than 10, and this color neutrality in reflection is maintained for angles of incidence between 0° and 70°.

Examples 1 and 2 are to be compared with known multilayers of the prior art, which form the subject of examples 3 and 4.

### EXAMPLES 3 and 4

(6): glass
(1): Si₃N₄ (index n₁=2.0)
(2): SiO₂ (index n₂=1.46)
(3): Si₃N₄ (index n₃=2.0)
(4): SiO₂ (index n₄=1.46)

The glass 6 of FIG. 1 was a clear silica-soda-lime glass 4 mm in thickness, sold under the name PLANILUX by Saint-Gobain Vitrage.

This glass was provided on both its faces with the antireflection multilayer:
SiO₂/Si₃N₄/SiO₂/Si₃N₄/glass/Si₃N₄/SiO₂/Si₃N₄/SiO₂.

The table below gives the index nᵢ and the geometrical thickness eᵢ in nanometers for each of the layers:

| | LAYER (1) | LAYER (2) | LAYER (3) | LAYER (4) |
|---|---|---|---|---|
| EXAMPLE 3 | | | | |
| nᵢ | 2.0 | 1.46 | 2.0 | 1.46 |
| eᵢ | 18 nm | 28 nm | 102 nm | 90 nm |
| EXAMPLE 4 | | | | |
| nᵢ | 2.0 | 1.46 | 2.0 | 1.46 |
| eᵢ | 35 nm | 19 nm | 50 nm | 90 nm |

The table below gives the optical parameters, in the (L*,a*,b*) plot, for various angles of incidence:

| | | | | | | | | | between Θ = 0° |
|---|---|---|---|---|---|---|---|---|---|
| Multilayer | Θ = 0° | Θ = 10° | Θ = 20° | Θ = 30° | Θ = 40° | Θ = 50° | Θ = 60° | Θ = 70° | and Θ = 70° |
| Example 3 | a* = 2 | a* = 2 | a* = 2 | a* = 5 | a* = 7 | a* = 8 | a* = 8 | a* = 6 | Δa* = 6 |
| | b* = −25 | b* = −25 | b* = −20 | b* = −15 | b* = −10 | b* = −7 | b* = −5 | b* = −3 | Δb* = 22 |
| Example 4 | a* = −5 | a* = −5 | a* = −0.6 | a* = 6.5 | a* = 12 | a* = 13 | a* = 10 | a* = 6.5 | Δa* = 18 |
| | b* = −5 | b* = −5 | b* = −4 | b* = −4 | b* = −2 | b* = 0.6 | b* = 2 | b* = 2 | Δb* = 7 |

The multilayer of example 3 was also suitable for building applications, but for an angle of incidence varying between 0° and 70° the color in reflection, expressed in the (L*,a*,b*) plot remained in the red-violet. This color is not recommended for such applications and is deemed to be unattractive. The optical properties remained constant over angles of incidence between 0° and 70°, but they did not conform to the aesthetic standards deemed to be acceptable in the building industry.

The color in reflection of the multilayer of example 4 passed from gray (for an angle of incidence of 0°) to blue (for an angle of incidence between 30 and 40°) and finally to red (for an angle of incidence of 70°).

In this example, the optical properties were not maintained.

In conclusion, the zirconium doping of at least one of the high-index layers (Si₃N₄) prevents the color in reflection from being very greatly modified as the angle of incidence varies.

In addition, according to one advantageous feature of the invention, the multilayers according to the invention (for example those of examples 1 and 2) may undergo heat treatments without impairing the optical properties.

The structure of the multilayer in question is repeated below:

### EXAMPLE 5

(6): glass
(1): Zr:Si₃N₄ (index n₁=2.2)
(2): SiO₂ (index n₂=1.46)
(3): Zr:Si₃N₄ (index n₃=2.2)
(4): SiO₂ (index n₄₌1.46)

The glass 6 of FIG. 1 was provided on both its faces with an antireflection coating according to the invention of the type:
SiO₂/Zr:Si₃N₄/SiO₂/Zr:Si₃N₄/glass/Zr:Si₃N₄/SiO₂/Zr:Si₃N₄/ SiO₂.

The geometrical thicknesses were the following:

| EXAMPLE 5 | LAYER (1) | LAYER (2) | LAYER (3) | LAYER (4) |
|---|---|---|---|---|
| nᵢ | 2.2 | 1.46 | 2.2 | 1.46 |
| eᵢ | 15 nm | 18 nm | 98 nm | 86 nm |

This multilayer (which was identical to the antireflection multilayer forming the subject of example 2) was subjected to an annealing-type heat treatment.

Its properties before annealing and after annealing are not substantially modified or impaired, as the table below showing the change in color in the (L*,a*,b*) plot demonstrates.

| Multilayer | Θ = 0° | Θ = 10° | Θ = 20° | Θ = 30° | Θ = 40° | Θ = 50° | Θ = 60° | Θ = 70° |
|---|---|---|---|---|---|---|---|---|
| Example 2 | a* = −4.8 | a* = −5.4 | a* = −6 | a* = −4.5 | a* = 1.5 | a* = 6.4 | a* = 7.5 | a* = 5.9 |
| | b* = −4.9 | b* = −3.6 | b* = −0.8 | b* = 1.0 | b* = −0.5 | b* = −2.7 | b* = −3.2 | b* = −2.3 |
| Example 5 | a* = −7.4 | a* = −7.6 | a* = −7.4 | a* = −4.6 | a* = 2.6 | a* = 7.5 | a* = 8.2 | a* = 6.1 |
| | b* = −2.2 | b* = −1.4 | b* = 0.4 | b* = 1.0 | b* = −0.9 | b* = −2.6 | b* = −2.6 | b* = −1.6 |

The multilayers forming the subject of the next examples, 6 and 7, are of the solar control type, these being particularly designed for automobile application.

The combination of good optical quality and limited optical changes upon bending is achieved by a judicious choice of the different metal layers. The first layer of dielectric material (a) comprises an oxygen diffusion barrier layer. This layer consists of mixed silicon zirconium nitrides, optionally including at least one other metal such as aluminum. It may include a layer based on zinc oxide or mixed oxide of zinc and another metal, substoichiometric in oxygen.

The function of this dielectric layer is essentially to block the diffusion of oxygen into the interior of the multilayer, including at high temperature. Since the mixed nitride is substantially inert with respect to oxidizing attack, it undergoes no appreciable chemical (oxidative) or structural modification during a heat treatment of the toughening type. It therefore involves almost no optical modification of the multilayer as a result of heat treatment, especially in terms of light transmission level. This layer may also act as a barrier to the diffusion of species migrating from the glass, especially alkali metals. Furthermore, thanks to its refractive index close to 2.2, it is readily incorporated into a multilayer of the solar control type.

This layer may generally be deposited with a thickness of at least 10 nm, for example between 15 and 70 nm.

As was seen above, this first dielectric layer may be coated with a layer of another dielectric material such as zinc oxide (ZnO) and with a thickness of between 5 and 15 nm.

A lower metal layer (b) acting as “barrier” may consist of a metal X chosen from titanium, nickel, chromium, niobium and zirconium, or from a metal alloy containing at least one of these metals.

Advantageously, the thickness of the layer (b) is chosen to have a value sufficient for the metal layer to oxidize only partially during a heat treatment, such as toughening. Preferably, this thickness is less than or equal to 6 nm, lying and between 0.2 and 6 nm, preferably at least 0.4 nm or at least 1 nm, depending on the multilayer sequences envisioned.

A lower metal chosen from metals with a high affinity for oxygen limits the diffusion of residual oxygen through the functional layer and helps to prevent the appearance of defects of the haze or pitting type. Since the lower metal oxidizes little during the heat treatment, its thickness is advantageously chosen in such a way that it does not contribute to light absorption after the heat treatment.

The functional layer (c) is typically a silver layer, but the invention applies in the same way to other reflective metal layers, such as those of silver alloys, especially containing titanium or palladium, or layers based on gold or copper. Its thickness is especially from 5 to 20 nm, preferably around 7 to 15 nm.

As a variant, an upper metal layer (d) (acting as overbarrier) may consist of a metal Y chosen from titanium, nickel, chromium, niobium, zirconium and metal alloys containing at least one of these metals, different from the metal or alloy X of the layer (b). Advantageously, the metal Y is chosen from titanium, niobium and zirconium and is preferably titanium.

The thickness of the layer (d) is advantageously chosen so as to be sufficient for the metal layer to oxidize only partially during a heat treatment, such as toughening. Preferably, this thickness is less than or equal to 6 nm, lying between 0.2 and 6 nm and preferably at least 0.4 nm or at least 1 nm depending on the multilayer sequences envisioned.

An upper metal chosen from metals with a high affinity for oxygen also blocks the diffusion of oxygen through the multilayer and therefore effectively protects the functional silver layer. However, this oxidation of the upper metal results in a change in the light transmission and the maximum thickness of the upper metal layer (d) may be chosen so as to limit the ΔTL.

According to an alternative embodiment, the functional layer (c) typically made of silver, is in direct contact with the metal coatings (b) or (d) placed below or above it, (b) or (d) being based on zinc oxide or on a mixed oxide of zinc and another metal.

According to the abovementioned embodiments, the layers (b) and (d) are not simultaneously present in the multilayer—either the layer (b) is incorporated beneath the functional layer (c), the layer (d) being absent, or the layer (d) is incorporated above the functional layer (c), and in this case the layer (b) is omitted.

In contrast, according to another alternative embodiment, the layers (b) and (d) are simultaneously present.

The second layer of dielectric material (e) optionally containing zirconium has a function similar to the layer (a). It furthermore includes an oxygen diffusion barrier layer chosen from mixed silicon zirconium nitrides, optionally containing at least one other metal such as aluminum. (As in the case of the layer (a), the layer (e) may be supplemented with another layer based on another dielectric of the ZnO type, such as for example zinc oxide, and with a thickness of between 5 and 20 nm (Zr:Si₃N₄/ZnO).

This layer (e) may generally be deposited with a thickness of at least 10 nm, for example between 15 and 70 nm. It may especially have a thickness greater than that of the first dielectric layer (a).

Of course, within the context of the invention, it is possible to devise multilayers that incorporate at least two, or even three, standard multilayer sequences as described above. Of course, the thicknesses will be consequently adapted so as to preserve the optical and energy properties.

Thus, it is possible to have, for example the following multilayers:

(a)/ZnO for example /X/Ag for example /ZnO for example/(e);
(a)/ZnO for example /Ag for example /Y/ZnO for example/(e);
(a)/ZnO for example /X/Ag for example /Y/ZnO for example/(e);
(a)/ZnO for example /X/Ag for example /ZnO for example/(e)/ZnO
for example /X/Ag for example /ZnO for example/(e);
(a)/ZnO for example /Ag for example /ZnO for example/(e)/ZnO
for example /Ag for example /ZnO for example/(e);
(a)/ZnO for example /Ag for example /ZnO for example/(e)/ZnO
for example /Ag for example /ZnO for example/(e)/ZnO for
example /Ag for example /ZnO for example/(e);
and also combinations of the above sequences.

Given by way of example below are the thicknesses for a functional monolayer (i.e. a single functional layer c):
Thickness of the layer (a) is substantially equal to the thickness of the layer (e), and is between 10 and 40 nm.

For a bilayer (i.e. two functional layers c):
Thickness of the layer (a) is substantially equal to the thickness of the layer (e), and is between 10 and 40 nm, and the intermediate layer (a′ or e′) has a thickness of between 5 and 70 nm.

For a trilayer (i.e. three functional layers c):
Thickness of the layer (a) is substantially equal to the thickness of the layer (e), and is between 10 and 40 nm, and the intermediate layers (a′ and a″ or e′ and e″) have a thickness of between 5 and 70 nm.

Advantageously, at least one of the dielectric coatings may include a layer based on one or more metal oxides. In particular, the upper dielectric layer (e) may include, on its external surface, a layer sub/super stoichiometric in oxygen and/or nitrided layer (f), improving the scratch resistance of the multilayer, thus forming what is called an overcoat layer. This may be a layer based on zinc oxide or on a mixed oxide of zinc and another metal (of the Al type). It may also be based on oxides comprising at least one of the following metals: Al, Ti, Sn, Zr, Nb, W, Ta. An example of a mixed zinc oxide that can be deposited as a thin film according to the invention is a mixed zinc tin oxide containing an additional element such as antimony, as described in WO 00/24686. The thickness of this oxide layer may be from 0.5 to 7 nm.

According to another variant, the latter layer may be of the DLC type. With this type of multilayer, it is possible, while maintaining the optical properties, to improve the energy gain, or both simultaneously.

This improvement will be optimized depending on the envisioned applications, by judiciously choosing to substitute in layers (a) or (e), or both simultaneously, silicon nitride for a mixed silicon zirconium nitride, or optionally incorporating another metal (for example aluminum).

| Example 6 | X | ZnO | Ag | ZnO | X | Ag | X | T_{L}(%) | R_{L}(%) | a*(R) | b*(R) | R_{E}(%) |
|---|---|---|---|---|---|---|---|---|---|---|---|---|
| X = Al:Si₃N₄ | 25 | 10 | 8.5 | 10 | 69.6 | 9.9 | 29 | 76.4 | 10.7 | −5.1 | −2.2 | 29.8 |
| N = 2.0 | | | | | | | | | | | | |
| Zr:Al:Si₃N₄ | 23 | 10 | 9.4 | 10 | 67.5 | 11.5 | 28 | 76.2 | 10.6 | −5.0 | −2.6 | 31.6 |
| N = 2.2 | | | | | | | | | | | | |

| Example 7 | X | Ag | X | Ag | X | T_{L}(%) | R_{L}(%) | a*(R) | b*(R) | R_{E}(%) |
|---|---|---|---|---|---|---|---|---|---|---|
| X = Al:Si₃N₄ | 25 | 9.3 | 65.3 | 11 | 29.5 | 76.0 | 9.7 | −2.0 | −5.1 | 33.0 |
| N = 2.0 | | | | | | | | | | |
| X = Zr:Al:Si₃N₄ | 24 | 10.3 | 63.5 | 12.5 | 28 | 76.0 | 9.6 | −2.1 | −5.2 | 35.1 |
| N = 2.2 | | | | | | | | | | |

The energy gain is reflected in an increase by about 10% in the total silver thickness and an increase by about 1.5% in RE. The optical parameters a*, b*, T_{L}(%) and R_{L}(%) remain unchanged.

Example 8 is an example of a multilayer of the enhanced thermal insulation (low E) type with a low solar factor.

The optical properties a*, b*, T_{L}(%), R_{L}(%) and T_{E}(%) of a glazing unit comprising this type of multilayer are compared with one incorporating the modalities of the invention.

The glazing in question is that sold by the Applicant under the brand name PLANISTAR. The optical parameters are the following (FILMSTAR simulations):
T_{L=}69.9% Rₑₓₜ₌10.5% T_{E=}38.2%
L*=82.6 L*=38.8%
a*=−5.0 a*=−2.2
b*=2.7 b*=−2.1

When Zr:Si₃N₄ is used within the multilayer (FILMSTAR simulations), the optical parameters become:

### EXAMPLE 8

T_{L}=70.2% Rₑₓₜ=10.0% T_{E}=37.0%
L*=83.0 L*=38.1%
a*=−4.1 a*=−2.1
b*=1.2 b*=−1.8

In conclusion, it may be noted that the use of Zr-doped silicon nitride makes it possible to improve the solar-protection performance of the product (by about 1% with regard to T_{E} or the solar factor) thanks to an increase in the silver thickness), while lowering the level of reflection of the product (−0.5%).

Examples 9 and 10 illustrate a variant of the invention in which provision is made, while maintaining the optical properties, to improve the mechanical resistance (scratch resistance and resistance to mechanical and chemical attack).

This example repeats the multilayer forming the subject of example 2 (antireflection coating) to which a protective overlayer made of DLC is added.

### EXAMPLES 9 and 10

(6): glass
(1): Zr:Si₃N₄ (index n₁=2.2)
(2): SiO₂ (index n₂=1.46)
(3): Zr:Si₃N₄ (index n₃=2.2)
(4): SiO₂ (index n₄=1.46)
(5): DLC (index n₅=1.85)

The glass 6 of FIG. 1 was provided on both its faces with an antireflection coating according to the invention of the type:
DLC/SiO₂/Zr:Si₃N₄/SiO₂/Zr:Si₃N₄/glass/Zr:Si₃N₄/SiO₂/Zr:Si₃ N₄/SiO₂/DLC.

The table below gives the index nᵢ and the geometrical thickness eᵢ in nanometers for each of the layers:

| | LAYER | LAYER | LAYER | LAYER | LAYER |
|---|---|---|---|---|---|
| | (1) | (2) | (3) | (4) | (5) |
| EXAMPLE 9 | | | | | |
| nᵢ | 2.2 | 1.46 | 2.2 | 1.46 | 1.85 |
| eᵢ | 14 nm | 19 nm | 98 nm | 78 nm | 5 nm |
| EXAMPLE 10 | | | | | |
| nᵢ | 2.2 | 1.46 | 2.2 | 1.46 | 1.85 |
| eᵢ | 17 nm | 18 nm | 98 nm | 70 nm | 10 nm |

Given below for these examples 9 and 10 are the optical properties compared with the reference properties taken from Example 2

| | T_{L}(%) | R_{L}(%) | A(%) |
|---|---|---|---|
| Example 2 | 98.6 | 0.6 | 0.8 |
| Example 9 | 98.4 | 0.6 | 1.6 |
| Example 10 | 98.1 | 0.65 | 1.3 |

After the Taber test (650 revolutions, 500 g; CS-10F wheels), a haze of between substantially 1 and 4% was observed.

Given below as example 11 is a multilayer of the solar control type.

Multilayer of the type: glass/Zr:Si₃N₄/ZnO/NiCr/Ag/ZnO/Zr:Si₃N₄/SnZnOx

The Ag, ZnO, NiCr underbarrier and SnZnOₓ overcoat thicknesses are constant.

| | | Emissivity | Transmission | | | | | Reflection (multilayer side) | | | | |
|---|---|---|---|---|---|---|---|---|---|---|---|---|
| Type | R_{□} | Eₙ/E_{eff} | T_{L} | l* | a* | b* | ΔE | R_{L} | l* | a* | b* | ΔE |
| Controls with | 6.5 | 6.3/7.4 | 87 | 94.8 | −2.9 | 0.3 | 2.0 | 4.6 | 25.4 | 7.3 | −0.5 | 3.2 |
| Al:Si₃N₄ | | | | | | | | | | | | |
| Multilayer with | 5.7 | 5.8/6.8 | 87.4 | 94.9 | −2.3 | 0.4 | 1.7 | 4.4 | 25.1 | 4 | −2.4 | 2.9 |
| Zr:Al:Si₃N₄ | 5.6 | 5.8/6.8 | 87 | 94.8 | −2.5 | 0.2 | 1.9 | 4.9 | 26.4 | 5.7 | 0.5 | 3.2 |

It may be noted that the value of a* decreases in the case of silicon nitride incorporating zirconium, and likewise it should be noted that there is a reduction in the value of Ro from 6.5 ohms to 5.6 ohms and a reduction in the normal emissivity.

Given below as example 12 is a solar-protection multilayer structure for automobiles, based on a silver bilayer:
Interior/glass/Zr: Si₃N₄/ZnO/Ag/ZnO/Zr: Si₃N₄/ZnO/Ag/ZnO/Zr:Si₃N₄/PVB/glass/exterior

| | T_{L}(%) | | R_{L}(%) | R_{E} | a* | b* | R_{□} |
|---|---|---|---|---|---|---|---|
| | (A/2°) | T_{E}(%) | (D₆₅/2°) | (%) | (Rₑₓₜ) | (Rₑₓₜ) | (ohms) |
| Al:Si₃N₄ | 76.6 | 47.2 | 11.7 | 29.4 | −4.8 | −2.9 | 3.4 |
| (Al, Zr): | 79.4 | 48.2 | 10.7 | 31.1 | −4.8 | −2.2 | 2.5 |
| Si₃N₄ | | | | | | | |

Here again it should be noted that there is a reduction in R□ for substantially identical optical properties.

Given below as example 13 is a solar-protection multilayer structure for automobiles, based on a silver trilayer (heated window):
Interior/glass/(Al, Zr) Si₃N₄/ZnO/Ag/Ti/ZnO/(Al, Zr):Si₃N₄/ZnO/Ag/Ti/ZnO/ (Al, Zr):Si₃N₄/ZnO/Ag/Ti/Zn/(Al, Zr) :Si₃N₄/PVB/glass/exterior.

| | T_{L}(%) | T_{E} | R_{L}(%) | R_{E} | a* | b* | R_{□} |
|---|---|---|---|---|---|---|---|
| | (A/2°) | (%) | (D₆₅/2°) | (%) | (Rₑₓₜ) | (Rₑₓₜ) | (ohms) |
| Control | 68.0 | 29.6 | 11.5 | 45.1 | −5.2 | 9.1 | 1.13 |
| Al:Si₃N₄ | | | | | | | |
| Neutral | 70.8 | 32.1 | 12.4 | 43.5 | −2.6 | −2.15 | 0.99 |
| (Al, Zr):Si₃N₄ | | | | | | | |
| Green | 70.4 | 31.8 | 12.0 | 43.5 | −5.4 | −0.9 | 1.03 |
| (Al, Zr):Si₃N₄ | | | | | | | |
| Green/yellow | 70.5 | 31.4 | 11.5 | 43.8 | −7.65 | +3.7 | 1.00 |
| (Al, Zr):Si₃N₄ | | | | | | | |

Here again, it should be noted that there is a reduction in R□ for the multilayers incorporating zirconium-doped silicon nitride (from 1.13 to approximately 1.00). The light transmission is also higher and the colors are more attractive (in reflection on the external side).

Lastly, the final example 14 is a multilayer structure based on four functional silver layers.

| | T_{E} | T_{L}(ill. A) | a*(ill. A) | b*(ill. A) | R_{E} | R_{L} | a* | b* | R_{□}(ohms) |
|---|---|---|---|---|---|---|---|---|---|
| Al:Si | 31.2 | 69.7 | −7.0 | −3.1 | 40.5 | 8.2 | −1.8 | −2.4 | 1.04 |
| Al, Zr:Si | 32.7 | 70.7 | −4.8 | 0.5 | 38.9 | 8.4 | −2.4 | −5.5 | 1.01 |

1. A transparent substrate, comprising an antireflection coating on at least one of its faces, which is made of a thin-film multilayer (A) of dielectric material with alternately high and low refractive indexes, characterized in that at least one of the layers of high refractive index comprises a mixed silicon zirconium nitride, the refractive index of at least one of the high-index layers being between 2.10 and 2.30.

2. The substrate as claimed in claim 1, characterized in that the atomic percentage of zirconium within the high-index layer is such that Si/Zr is between 4.6 and 5.

3. The substrate as claimed in claim 1, characterized in that the layer of high refractive index is doped using a metal.

4. The substrate as claimed in claim 1, characterized in that it comprises, in succession:
a high-index first layer (1) having a refractive index n₁ of between 2.1 and 2.3 and a geometrical thickness e₁ of between 5 and 50 nm;
a low-index second layer (2) having a refractive index n₂ of between 1.35 and 1.65 and a geometrical thickness e₂ of between 5 and 50 nm;
a high-index third layer (3) having a refractive index n₃ of between 2.1 and 2.3 and a geometrical thickness e₃ of between 40 and 120 nm; and
a low-index fourth layer (4) having a refractive index n₄ of between 1.35 and 1.65 and a geometrical thickness e4 of between 40 and 120 mn.

5. The substrate as claimed in claim 4, characterized in that the low-index second layer (2) and/or the low index fourth layer (4) are based on silicon oxide, silicon oxynitride and/or silicon oxycarbide or on a mixed silicon aluminum oxide.

6. The substrate as claimed in claim 4, characterized in that the high-index first layer (1) and/or the high-index third layer (3) consist of a superposition of several high-index layers, at least one of the layers comprising a mixed silicon zirconium nitride.

7. The substrate as claimed in claim 1, characterized in that its light reflection on the side where it is provided with the thin-film multilayer is lowered by a minimum amount of 3 or 4% at normal incidence.

8. The substrate as claimed in claim 1, characterized in that the colorimetric response of its light reflection on the side where it is provided with the thin-film multilayer is such that the corresponding value of b* in the (L*,a*,b*) colorimetry system is negative, for a 0° angle of incidence.

9. The substrate as claimed in claim 1, characterized in that the colorimetric response of its light reflection on the side where it is provided with the thin-film multilayer is such that the variation in the parameters expressed in the (L*,a*,b*) colorimetry system with angle of incidence varying between 0° and 70° is limited in absolute value to 10.

10. The substrate as claimed in claim 1, characterized in that the multilayer uses at least one high-index layer based on a mixed silicon zirconium nitride so that it has a very high mechanical durability, such thatΔH in the Taber test is less than 4% after 650 revolutions.

11. Multiple glazing, comprising at least two substrates as claimed in claim 1, characterized in that the two glass substrates (6) are joined together by means of a sheet (7) of thermoplastic material or by means of an intermediate seal in the case of a double glazing unit, said substrate (6) being provided on the opposite side from the join:
either with an antireflection multilayer;
or with a coating having another functionality, of solar-protection, low-emissivity, antisoiling, antifogging, antirain, heating or electromagnetic shielding, it being possible for said coating having another functionality to be on one of the faces of the substrates turned toward the thermoplastic joining sheet,
said substrate being provided on the joining side with a coating having electromagnetic wave shielding properties.

12. A transparent substrate, provided with a thin-film multilayer comprising an alternation of n functional layers having reflection properties in the infrared and/or in solar radiation and n+1 coatings composed of one or more layers of dielectric material, in such a way that each functional layer is placed between two coatings, characterized in that at least one of the layers of dielectric material is based on a mixed silicon zirconium nitride, the Si/Zr atomic percentage ratio being between 4.6 and 5 and its refractive index being between 2.0 and 2.3.

13. The substrate as claimed in claim 12, characterized in that the multilayer comprises a single functional layer placed between two coatings.

14. The substrate as claimed in claim 12, characterized in that the multilayer comprises two functional layers alternating with three coatings.

15. The substrate as claimed in claim 12, characterized in that the multilayer comprises three functional layers alternating with four coatings.

16. The substrate as claimed in claim 12, characterized in that the functional layer is based on silver, a silver mixture, gold or palladium.

17. The substrate as claimed in claim 12, characterized in that it comprises:
a first high-index dielectric layer having a refractive index of between 2.1 and 2.3 and a geometrical thickness of between 10 and 40 nm;
a first functional layer; and
a second high-index dielectric layer having a refractive index of between 2.1 and 2.3 and a geometrical thickness of between 15 and 40 nm.

18. The substrate as claimed in claim 12, characterized in that it comprises:
a first high-index dielectric layer having a refractive index of between 2.1 and 2.3 and a geometrical thickness of between 10 and 40 nm;
a first functional layer;
a second high-index dielectric material having a refractive index of between 2.1 and 2.3 and a geometrical thickness of between 5 and 70 nm;
a second functional layer; and
a third high-index dielectric layer having a refractive index of between 2.1 and 2.3 and a geometrical thickness of between 10 and 40 nm.

19. The substrate as claimed in claim 12, characterized in that it comprises:
a first high-index dielectric layer having a refractive index of between 2.1 and 2.3 and a geometrical thickness of between 10 and 40 nm;
a first functional layer;
a second high-index dielectric layer having a refractive index of between 2.1 and 2.3 and a geometrical thickness of between 5 and 70 nm;
a second functional layer;
a third high-index dielectric layer having a refractive index of between 2.1 and 2.3 and a geometrical thickness of between 5 and 70 nm;
a third functional layer; and
a fourth high-index dielectric layer having a refractive index of between 2.1 and 2.3 and a geometrical thickness of between 10 and 40 nm.

20. The substrate as claimed in claim 19, characterized in that the layers absorbent in the visible, positioned beneath at least one functional layer, are chosen to be based on a metal or a metal alloy, with a thickness of at least 1 nm.

21. The substrate as claimed in claim 19, characterized in that the layers absorbent in the visible, positioned on top of at least one functional layer, are chosen to be based on a metal or a metal alloy, with a thickness of at least 1 nm.

22. The substrate as claimed in claim 12, characterized in that it includes a cover layer based on an oxide, and/or nitrided.

23. The substrate as claimed in claim 1 characterized in that it includes a DLC-based overcoat.

24. The substrate as claimed in claim 23, characterized in that the thickness of the overcoat is between 5 and 10 nm.

25. The substrate as claimed in claim 12, characterized in that each of the functional layers is on top of a multilayer coating whose last layer is based on zinc oxide or on a mixed oxide of zinc and another metal.

26. The substrate as claimed in claim 12, characterized in that each of the functional layers is beneath a multilayer coating whose first layer is based on zinc oxide or on a mixed oxide of zinc and another metal.

27. The substrate as claimed in claim 26, characterized in that the layer based on zinc oxide or on a mixed oxide of zinc and another metal is substoichiometric in oxygen.

28. The substrate as claimed in claim 1, characterized in that it is capable of undergoing a heat treatment.

29. The substrate as claimed in claim 12, characterized in that the multilayer is as follows:
Zr: Si₃N_{4/}ZnO/Ti/Ag/ZnO/Zr:Si3N4/ZnO/Ti/Ag/ZnO/Zr: Si₃N₄ or Zr:Si₃N_{4/}ZnO/Ag/NiCr/ZnO/Zr:Si₃N₄
optionally with thin layers of partially or completely oxidized metal placed on one of the faces of at least each of the silver layers.

30. Glazing incorporating at least one substrate as claimed in claim 1, characterized in that it is in the form of laminated glazing, a symmetrical glazing or multiple glazing.

31-32. (canceled)

33. A plane or tubular, magnetron sputtering target for obtaining at least one layer comprising SiₓZr_{y}Al_{z} on a portion of the surface of a substrate as claimed in claim 1, characterized in that the Si/Zr ratio at the target is slightly different from that of the layer, with a difference of 0.1 to 0.5.
